(19) United States
(12) Patent Application Publication
(10) Pub. No.: US 2026/0244261 A1
(43) Pub. Date: Aug. 20, 2026

(54) DISPLAY CONTROL APPARATUS

(71) Applicant: NTT DOCOMO, INC., Chiyoda-ku (JP)

(72) Inventor: Keishirou KATAOKA, Chiyoda-ku (JP)

(73) Assignee: NTT DOCOMO, INC., Chiyoda-ku (JP)

(21) Appl. No.: 19/473,367

(22) PCT Filed: Mar. 27, 2024
(86) PCT No.: PCT/JP2024/012471

§ 371 Date: Oct. 7, 2025

(30) Foreign Application Priority Data
Apr. 19, 2023 (JP) 2023-068495

(51) Int. Cl. G06F 3/01; G06T 13/40; G06T 15/10

(52) U.S. Cl. CPC G06F 3/011; G06T 13/40; G06T 15/10; G06F 2203/011; G06F 2203/012

(57) ABSTRACT

A display control apparatus includes a display controller configured to cause an avatar image indicative of an avatar corresponding to a user to be displayed in a virtual space, a generator configured to generate value information relating to a sense of values of the user, and an effect imparter configured to add a visual effect to the avatar image in accordance with the value information generated by the generator.

### TECHNICAL FIELD

The present invention relates to display control apparatuses.

### BACKGROUND ART

A user watching a virtual space may contact another person via the use of an avatar. Such communication includes not only linguistic communication, but also non-linguistic communication.

For example, Patent Document 1 discloses a technique relating to an image generating apparatus that reflects movement of a real performer in movement of a character in a virtual space. A database managed by the image generating apparatus stores an emotion attribute in association with each of a plurality of words that may be shown by the performer, an emotion attribute in association with each of a plurality of possible states of the performer, and a plurality of operation commands for controlling movement of the character. The operation commands include a visual effect command for adding a visual effect to an image of the character. The above-described image generating apparatus adds a visual effect to the character based on the above-described database.

### RELATED ART DOCUMENT

### Patent Document

Patent Document 1: Japanese Patent Application, Laid-Open Publication No. 2019-024748

### SUMMARY OF THE INVENTION

### Problem to be Solved by the Invention

A user may carry out a movement for the purpose of satisfying a potential desire that is based on a sense of values of the user. More specifically, a potential desire arises based on a sense of values included in a deep psychology of the user. To satisfy this potential desire, a motive for movement of the user arises. In addition, an emotion of the user arises based on a degree and a way to satisfy the potential desire due to the movement of the user.

In the prior art, a visual effect dependent on an emotion of a user is added to a character; thus, a different user can know the current emotion of the user who has the character to which the visual effect is added. However, a problem occurs in that the different user can know the current emotion, but cannot know the sense of values of the user who has the character to which the visual effect is added.

Accordingly, an object of the present invention is to provide a display control apparatus that adds, based on the sense of values of a user, a visual effect to an avatar.

### Means for Solving Problem

A display control apparatus according to a preferred aspect of the present invention includes a display controller configured to cause an avatar image indicative of an avatar corresponding to a user to be displayed in a virtual space, a generator configured to generate value information relating to a sense of values of the user, and an effect imparter configured to add a visual effect to the avatar image in accordance with the value information generated by the generator.

### Effect of Invention

According to the present invention, it is possible to add a visual effect, which is based on a sense of values of a user, to an avatar.

### BRIEF DESCRIPTION OF THE DRAWINGS

FIG. 1 is a diagram showing an overall configuration of a display control system 1.

FIG. 2 is a block diagram showing an example of a configuration of a server 10. FIG. 3 is a diagram showing examples of an avatar image APJ and an additional image DPJ.

FIG. 4 is a diagram showing examples of an avatar image APK and an additional image DPK.

FIG. 5 is a diagram showing examples of change in the additional image DPJ and the additional image DPK.

FIG. 6 is a diagram showing examples of change in the additional image DPJ and the additional image DPK.

FIG. 7 is a diagram showing an individual space VSJ.

FIG. 8 is a block diagram showing an example of a configuration of a terminal device 30.

FIG. 9 is a flowchart showing an example of an operation of the server 10 adding a visual effect to the avatar image APJ.

FIG. 10 is a flowchart showing an example of an operation in which an avatar AK is permitted to move to the individual space VSJ.

### MODES FOR CARRYING OUT THE INVENTION

### 1: Embodiment

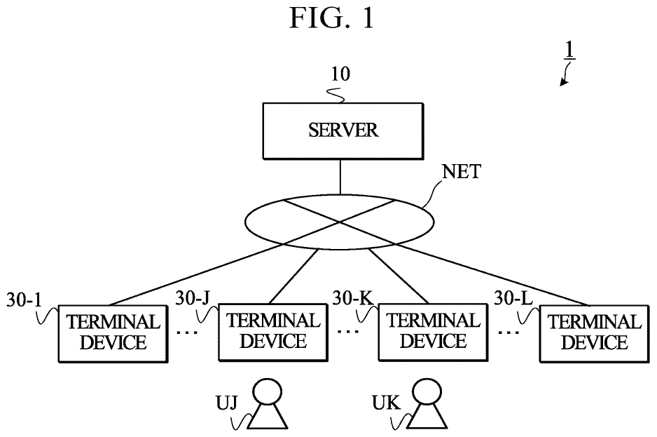

With reference to FIG. 1 through FIG. 10, a display control system 1 including a server 10 according to an embodiment of the present invention will be explained below.

### 1-1: Configuration of Embodiment

### 1-1-1: Overall Configuration

FIG. 1 shows an overall configuration of a display control system 1 according to an embodiment. As shown in FIG. 1, the display control system 1 includes the server 10 and terminal devices 30-1, 30-2 . . . 30-J . . . 30-K . . . 30-L. L is an integer greater than or equal to 1. K is an integer greater than or equal to 1 and less than or equal to L. J is an integer greater than or equal to 1 and less than or equal to K. In the present embodiment, the terminal device 30-1 through the terminal device 30-L have the same configuration. However, a terminal device having a different configuration may be included.

In the display control system 1, the server 10 and the terminal device 30-1 through the terminal device 30-L are connected to, and are communicable with, each other via a communication network NET. It should be noted that in FIG. 1, a user UJ uses the terminal device 30-J. A user UK uses the terminal device 30-K. The user UJ is an example of a “first user.” In addition, the user UK is an example of a “second user.”

A terminal device 30 causes a display 34, which is provided in the terminal device 30 and is described below, to display a virtual object placed in a virtual space.

The “virtual object” is, for example, a virtual object representative of data such as a still image, a video, a 3D-CG model, HTML file, and a text file. Here, text, memos, and source codes, which indicate the contents of a chat between users U, are given as examples of the text file.

It should be noted that an example of the terminal device 30 is preferably a mobile terminal device such as a smartphone, a tablet, etc.

The server 10 provides the terminal device 30 with various pieces of data and cloud services via the communication network NET. The server 10 provides the terminal device 30 with various pieces of information for causing the terminal device 30 to display an avatar image APJ, which is representative of an avatar AJ corresponding to the user UJ, and an avatar image APK, which is representative of an avatar AK corresponding to the user UK. The server 10 is an example of a “display control apparatus.” The avatar AJ is an example of a “first avatar.” The avatar AK is an example of a “second avatar.” The avatar image APJ is an example of a “first avatar image.” The avatar image APK is an example of a “second avatar image.”

### 1-1-2: Configuration of Server 10

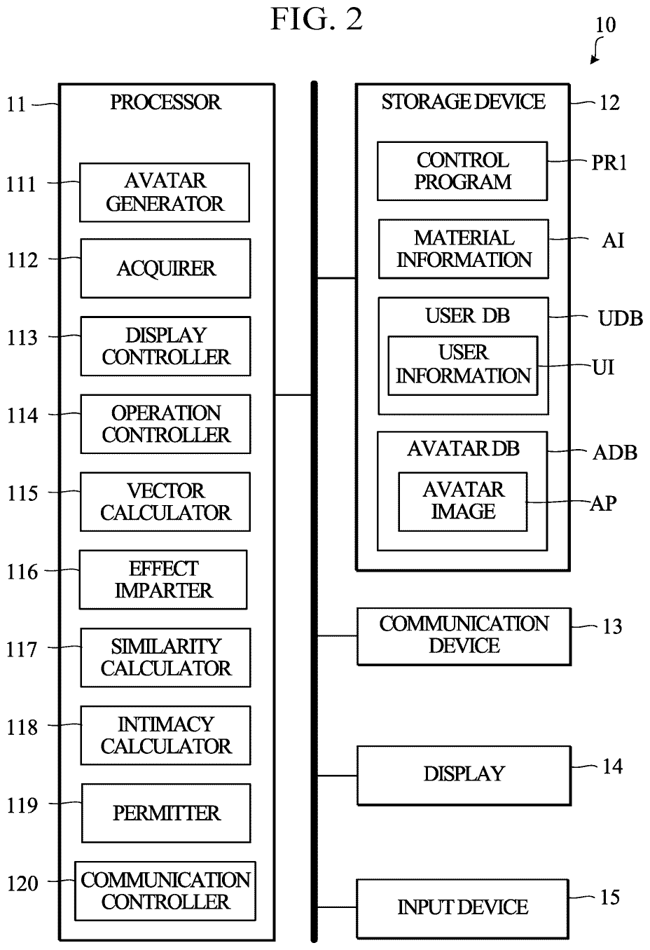

FIG. 2 is a block diagram showing an example of a configuration of the server 10. The server 10 includes a processor 11, a storage device 12, a communication device 13, a display 14, and an input device 15. Each element of the server 10 is interconnected by a single bus or by multiple buses for communicating information.

The processor 11 is a processor that controls the entire server 10. In addition, the processor 11 is constituted by use of a single chip or by use of multiple chips, for example. The processor 11 is constituted by use of a central processing unit (CPU) that includes, for example, interfaces for peripheral devices, arithmetic units, registers, etc. It should be noted that some or all of the functions of the processor 11 may be implemented by hardware such as a DSP, an ASIC, a PLD, or a FPGA, etc. The processor 11 executes various types of processing in parallel or sequentially.

The storage device 12 is a recording medium that the processor 11 can read from and write to. In addition, the storage device 12 stores a plurality of programs including a control program PR1 to be executed by the processor 11. In addition, the storage device 12 stores material information AI relating to materials of avatars. The material information AI is information indicative of materials, which are of an avatar image AP and are used in a case in which an avatar generator 111 described below generates the avatar image AP. In addition, the storage device 12 stores a user database UDB and an avatar database ADB. The user database UDB stores a user ID for uniquely identifying a user U, user information UI relating to the user U, and a vector relating to a sense of values of the user U, which are in association with one another. The user information UI is information relating to an attribute of the user U. The attribute of the user U includes, for example, age, gender, height, weight, and personality. The user information UI is, for example, information input, as a response to a survey of every user U, by a manager of the display control system 1 through the input device 15 described below. In addition, the vector relating to the sense of values of the user U is constituted of a plurality of elements. A value of each of the plurality of elements is calculated by a vector calculator 115 described below. The avatar database ADB stores the user ID and the avatar image AP generated by the avatar generator 111 described below, which are in association with each other.

The communication device 13 is hardware as a transmitting and receiving device configured to communicate with other devices. For example, the communication device 13 may be referred to as a network device, a network controller, a network card, a communication module, etc. The communication device 13 may include a connector for wired connection and may include an interface circuit corresponding to the connector. In addition, the communication device 13 may include a wireless communication interface. The connector for wired connection and the interface circuit may conform to wired LAN, IEEE1394, or USB. In addition, the wireless communication interface may conform to wireless LAN or Bluetooth (registered trademark), etc.

The display 14 is a device that displays images and text information. The display 14 displays various images under the control of the processor 11. For example, various display panels, such as liquid crystal display panels, and organic electro-luminescent (EL) display panels, are suitably used as the display 14.

The input device 15 is a device that receives an operation made by the manager of the display control system 1. For example, the input device 15 includes a keyboard and a pointing device such as a touch pad, a touch panel, or a mouse.

The processor 11 reads the control program PR1 from the storage device 12, for example. The processor 11 executes the read control program PR1 to function as the avatar generator 111, an acquirer 112, a display controller 113, an operation controller 114, a vector calculator 115, an effect imparter 116, a similarity calculator 117, an intimacy calculator 118, a permitter 119, and a communication controller 120.

The avatar generator 111 generates the avatar image AP indicative of an avatar A by using the materials indicated by the material information AI. The avatar generator 111 may further generate the avatar image AP by reflecting the information relating to the attribute of the user U included in the user information UI. For example, age and gender correspond to the attribute of the user U. More particularly, the avatar generator 111 uses the material information AI and user information UIJ relating to the user UJ to generate the avatar image APJ indicative of the avatar AJ corresponding to the user UJ. In addition, the avatar generator 111 uses the material information AI and user information UIK relating to the user UK to generate the avatar image APK indicative of the avatar AK corresponding to the user UK. The avatar image AP may be a two-dimensional image or may be a three-dimensional image. Furthermore, the avatar generator 111 stores the generated avatar image AP in the avatar database ADB.

The acquirer 112 acquires, from the terminal device 30, operation information for operating the avatar A. In addition, the acquirer 112 acquires, from the terminal device 30, communication information input by the user U. Here, “communication” refers to conversations made by the user UJ and the user UK using speech, and exchanges of messages using text. “Exchanges of messages using text” refers to transmitting and receiving of email, and chat, specifically. The communication information includes audio information indicative of speech exchanged between the user UJ and the user UK. In addition, the communication information includes text information indicative of text exchanged between the user UJ and the user UK.

The display controller 113 causes the terminal device 30 to display a virtual space VS that includes the avatar image AP indicative of the avatar A corresponding to the user U. For example, the display controller 113 causes each of the terminal device 30-J and the terminal device 30-K to display the virtual space VS, which includes the avatar image APJ indicative of the avatar AJ corresponding to the user UJ and the avatar image APK indicative of the avatar AK corresponding to the user UK.

The operation controller 114 causes, based on the operation information acquired by the acquirer 112, the avatar image AP to move in the virtual space VS. For example, the operation controller 114 causes, based on the operation information acquired from the terminal device 30-J, the avatar image APJ to move in the virtual space VS. In addition, the operation controller 114 causes, based on the operation information acquired from the terminal device 30-K, the avatar image APK to move in the virtual space VS.

The vector calculator 115 calculates a vector V relating to a sense of values of the user U as value information relating to the sense of values of the user U. More specifically, the vector calculator 115 calculates the vector V based on movement of the user U in the virtual space VS. The movement of the user U includes, for example, transmission of a message by the user U, use of a service in the virtual space VS by the user U, purchase of a virtual object in the virtual space VS by the user U, a visit to a place in the virtual space VS by the user U, participation in a community in the virtual space VS by the user U, etc. When the movement of the user U is transmission of a message by the user U, the vector calculator 115 calculates the vector V based on a word contained in a message transmitted by the user U in the virtual space VS. It should be noted that the movement of the user U may include movement in a real space, in addition to movement in the virtual space VS. The vector calculator 115 is an example of a “generator.”

In addition, the vector calculator 115 calculates a vector VJ relating to a sense of values of the user UJ and a vector VK relating to a sense of values of the user UK, for example. The vector VJ is an example of a “first vector.” In addition, the vector VK is an example of a “second vector.” The vector calculator 115 calculates the vector VJ by applying a training technique, in which a graph neural network is used, to a graph generated based on a movement history of the user UJ, for example. Similarly, the vector calculator 115 calculates the vector VK by applying the training technique, in which a graph neural network is used, to a graph generated based on a movement history of the user UK, for example.

In FIG. 2, the effect imparter 116 adds a visual effect to the avatar image AP in accordance with the vector V calculated by the vector calculator 115. More specifically, the effect imparter 116 adds an additional image DP dependent on the sense of values of the user U, as the visual effect, around the avatar image AP. For example, the effect imparter 116 adds an additional image DPJ, which is dependent on the sense of values of the user UJ, around the avatar image APJ corresponding to the user UJ. In addition, the effect imparter 116 adds an additional image DPK, which is dependent on the sense of values of the user UK, around the avatar image APK corresponding to the user UK. The additional image DPJ is an example of a “first additional image.” In addition, the additional image DPK is an example of a “second additional image.”

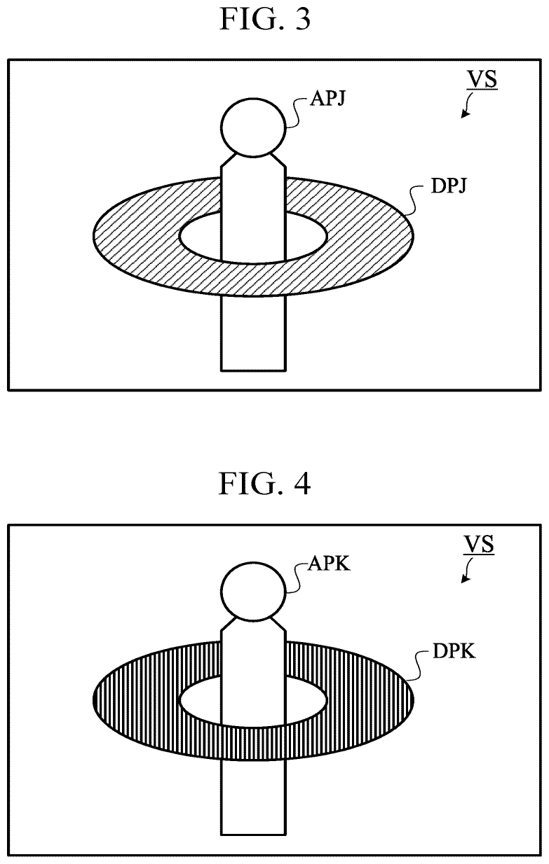

FIG. 3 is a diagram showing examples of the avatar image APJ and the additional image DPJ. FIG. 4 is a diagram showing examples of the avatar image APK and the additional image DPK. In the examples shown in FIG. 3, the additional image DPJ is represented as an aura that swirls around a body part of the avatar image APJ. At least one of the elements, which include a diameter, a thickness, a color, and a shape of the additional image DPJ that serves as an aura and a granularity of the pixels comprising the additional image DPJ, changes in accordance with a direction and a distance of the vector VJ relating to the sense of values of the user UJ. Similarly, in the examples shown in FIG. 4, the additional image DPK is represented as an aura that swirls around a body part of the avatar image APK. At least one of the elements, which includes a diameter, a thickness, a color and, a shape of the additional image DPK that serves as an aura, and a granularity of the pixels comprising the additional image DPK, changes in accordance with a direction and a distance of the vector VK relating to the sense of values of the user UK. For example, when the sense of values of the user UJ and the sense of values of the user UK are the same, the additional image DPJ and the additional image DPK are represented by use of the same color. On the other hand, when the sense of values of the user UJ and the sense of values of the user UK are different from each other, the additional image DPJ and the additional image DPK are represented by use of different colors. In the examples shown in FIG. 3 and FIG. 4, the user UJ and the user UK differ in sense of values from each other; thus, the additional image DPJ and the additional image DPK are represented by use of different colors.

In addition, in FIG. 2, the effect imparter 116 may add, as the visual effect, the additional image DPJ to the avatar image APJ in a case in which it is determined that the user UJ is in a state in which a conversation with the user UK is allowed in the virtual space VS. Here, the case in which it is determined that the user UJ is in a state in which a conversation with the user UK is allowed, is for example, a case in which the user UJ watches the virtual space VS using the terminal device 30-J and a distance between the avatar AJ and the avatar AK in the virtual space VS is less than or equal to a predetermined distance. The predetermined distance is, for example, a distance at which the user UK can watch the avatar image APJ corresponding to the user UJ. On the other hand, the effect imparter 116 is not required to add the additional image DPJ to the avatar image APJ in a case in which it is determined that the user UJ is in a state in which a conversation with the user UK is not allowed in the virtual space VS. The case in which it is determined that the user UJ is in a state in which a conversation with the user UK is not allowed includes, for example, a case in which the user UJ does not watch the virtual space VS due to the terminal device 30-J being turned off, and a case in which the distance between the avatar AJ and the avatar AK in the virtual space VS is greater than the predetermined distance.

The similarity calculator 117 calculates a degree of similarity between the sense of values of the user UJ and the sense of values of the user UK based on the vector VJ corresponding to the user UJ and the vector VK corresponding to the user UK. After each of the user UJ and the user UK starts communicating with a different user U in the virtual space VS, the similarity calculator 117 calculates the degree of similarity between the sense of values of the user UJ and the sense of values of the user UK based on a cosine similarity between the vector VJ and the vector VK. In addition, the similarity calculator 117 calculates, as the degree of similarity between the sense of values of the user UJ and the sense of values of the user UK, a higher value with a reduction in an angle between the vector VJ and the vector VK.

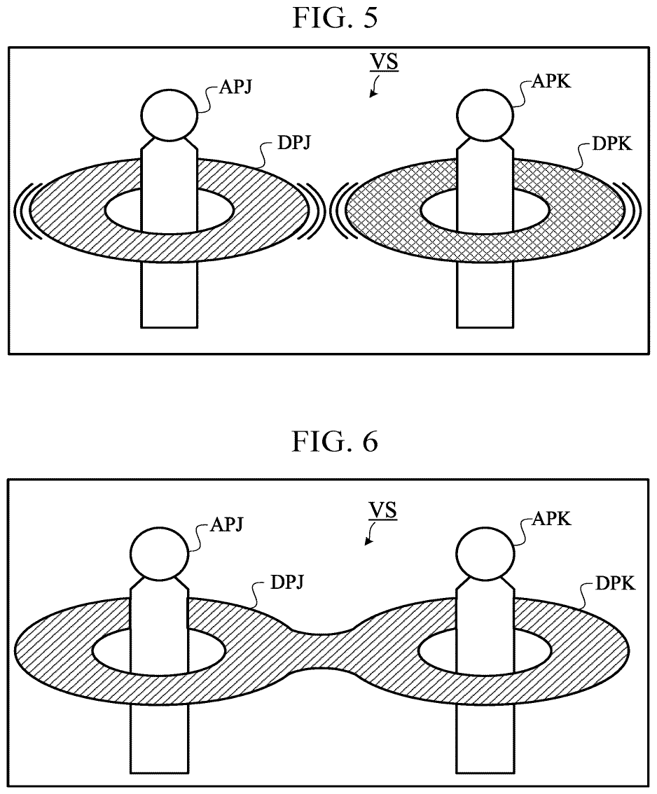

The effect imparter 116 changes the additional image DPJ, which is added to the avatar image APJ, and the additional image DPK, which is added to the avatar image APK, based on the degree of similarity calculated by the similarity calculator 117. FIG. 5 is a diagram showing examples of change in the additional image DPJ and the additional image DPK. In the examples shown in FIG. 5, a degree of swirling of each of the additional image DPJ and the additional image DPK changes based on the degree of similarity calculated by the similarity calculator 117. For example, the additional image DPJ and the additional image DPK swirl more violently as the degree of similarity calculated by the similarity calculator 117 is greater. Alternatively, a diameter of each of the additional image DPJ and the additional image DPK is increased, or is reduced, based on the degree of similarity calculated by the similarity calculator 117. For example, a diameter of each of the additional image DPJ and the additional image DPK becomes larger as the degree of similarity calculated by the similarity calculator 117 is greater.

When a person encounters a stranger in the real space, it is difficult for the person to recognize a degree of similarity between a sense of values of the person and a sense of values of a stranger, and the same is true in the virtual space VS. In the virtual space VS, an emotion of a different user U can be understood relatively easily by movement of an avatar A of the different user U being watched. However, in the virtual space VS, it is not easy to understand a sense of values of the different user U. The visual effect, which is based on the degree of similarity and is added by the effect imparter 116, is determined in accordance with an interaction between senses of values of users U, who encounter each other via avatars A in the virtual space VS. In encountering a different user U in the virtual space VS, a user U can visually recognize a degree of similarity between a sense of values of the user U and a sense of values of the different user U due to this visual effect being added.

In FIG. 2, the intimacy calculator 118 calculates a degree of intimacy indicative of a degree of intimacy between the user UJ and the user UK based on communication between the user UJ and the user UK. Specifically, the intimacy calculator 118 calculates an initial value of the degree of intimacy based on information relating to personalities of the user UJ and the user UK included in the user information UI stored in the user database UDB. Thereafter, the intimacy calculator 118 calculates a numerical value indicative of the degree of intimacy based on at least one of a total amount of text information included in a message exchanged between the user UJ and the user UK, the contents of the message, a time or the number of days between the first transmission or reception of the message between the user UJ and the user UK and the last transmission or reception, a length of a voice conversation between the user UJ and the user UK, a volume of the conversation, and the contents of the conversation. For example, the intimacy calculator 118 calculates, as a numerical value indicative of the degree of intimacy, a higher numerical value with an increase in the total amount of text information described above. In addition, the intimacy calculator 118 calculates, as a numerical value indicative of the degree of intimacy, a higher numerical value with an increase in the time or the number of days between the first transmission or reception of the message between the user UJ and the user UK and the last transmission or reception, for example. In addition, the intimacy calculator 118 calculates, as a numerical value indicative of the degree of intimacy, a higher numerical value with an increase in the length of a voice conversation between the user UJ and the user UK, for example. In addition, the intimacy calculator 118 calculates, as a numerical value indicative of the degree of intimacy, a higher numerical value with an increase in the volume of a voice conversation between the user UJ and the user UK, for example. Furthermore, in calculating the degree of intimacy based on the contents of the message exchanged between the user UJ and the user UK, the intimacy calculator 118 calculates the degree of intimacy based on a degree of the number of keywords that are included both in a message transmitted by the user UJ and in a message transmitted by the user UK, for example. Furthermore, in calculating the degree of intimacy based on the contents of a voice conversation between the user UJ and the user UK, the intimacy calculator 118 calculates the degree of intimacy based on a degree of the number of keywords that are included both in spoken content of the user UJ and in spoken content of the user UK, for example.

The effect imparter 116 changes the additional image DPJ, which is added to the avatar image APJ, and the additional image DPK, which is added to the avatar image APK, based on the degree of intimacy calculated by the intimacy calculator 118. FIG. 6 is a diagram showing examples of change in the additional image DPJ and the additional image DPK. In the examples shown in FIG. 6, when the degree of intimacy exceeds a predetermined value, the additional image DPJ and the additional image DPK are represented in the same color and are integrated with each other.

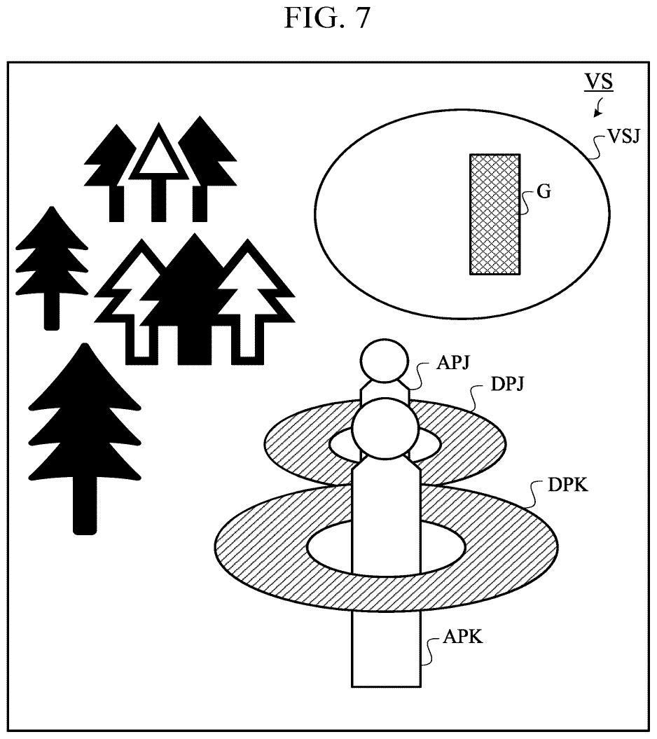

In FIG. 2, the permitter 119 permits the avatar AK to move to an individual space VSJ managed by the user UJ in the virtual space VS. The individual space VSJ is an example of a “first individual space.” FIG. 7 is a diagram showing the individual space VSJ. A surface of the individual space VSJ is provided with an entrance G for moving to the inside of the individual space VSJ.

For example, the permitter 119 permits, in accordance with the degree of similarity between the user UJ and the user UK calculated by the similarity calculator 117, the avatar AK to move to the individual space VSJ managed by the user UJ in the virtual space VS. For example, provided that the degree of similarity between the user UJ and the user UK calculated by the similarity calculator 117 exceeds a predetermined value, the display controller 113 causes the individual space VSJ to be displayed in the virtual space VS. The individual space VSJ is displayed in the virtual space VS displayed on the terminal device 30-J and on the terminal device 30-K, but is not displayed in the virtual space VS displayed on the other terminal devices 30. In other words, only the user UJ and the user UK among users U can visually recognize the individual space VSJ. When the individual space VSJ appears in the virtual space VS displayed on the terminal device 30-K used by the user UK, the permitter 119 permits the avatar AK corresponding to the user UK to move to the inside of the individual space VSJ through the entrance G.

Alternatively, the permitter 119 may permit the avatar AK to move to the individual space VSJ in accordance with the degree of intimacy between the user UJ and the user UK in addition to the degree of similarity between the user UJ and the user UK calculated by the similarity calculator 117. For example, provided that the degree of similarity between the user UJ and the user UK exceeds a first predetermined value, the display controller 113 causes the individual space VSJ to be displayed in the virtual space VS. After the display controller 113 causes the individual space VSJ to be displayed, provided that the degree of intimacy between the user UJ and the user UK exceeds a second predetermined value, the permitter 119 may permit the avatar AK corresponding to the user UK to move to the inside of the individual space VSJ through the entrance G.

Alternatively, the permitter 119 may permit the avatar AK to move to the individual space VSJ in accordance with a relative positional relationship between the avatar image APJ and the avatar image APK in the virtual space VS in addition to the degree of similarity and the degree of intimacy between the user UJ and the user UK. For example, provided that the degree of similarity between the user UJ and the user UK exceeds the predetermined value, the display controller 113 causes the individual space VSJ to be displayed in the virtual space VS. After the display controller 113 causes the individual space VSJ to be displayed, provided that the degree of intimacy between the user UJ and the user UK exceeds the second predetermined value and a distance between the avatar image APJ and the avatar image APK in the virtual space VS is less than a predetermined distance, the permitter 119 may permit the avatar AK to move to the inside of the individual space VSJ through the entrance G.

The communication controller 120 causes the communication device 13 to exchange various information with the terminal device 30. For example, the communication controller 120 causes the communication device 13 to receive, from a terminal device 30, the operation information for the user U to operate the avatar A and conversation information input by the user U. In addition, the communication controller 120 causes the communication device 13 to transmit image information for displaying the avatar image AP and movement information for moving the avatar image AP to the terminal device 30.

### 1-1-3: Configuration of Terminal Device 30

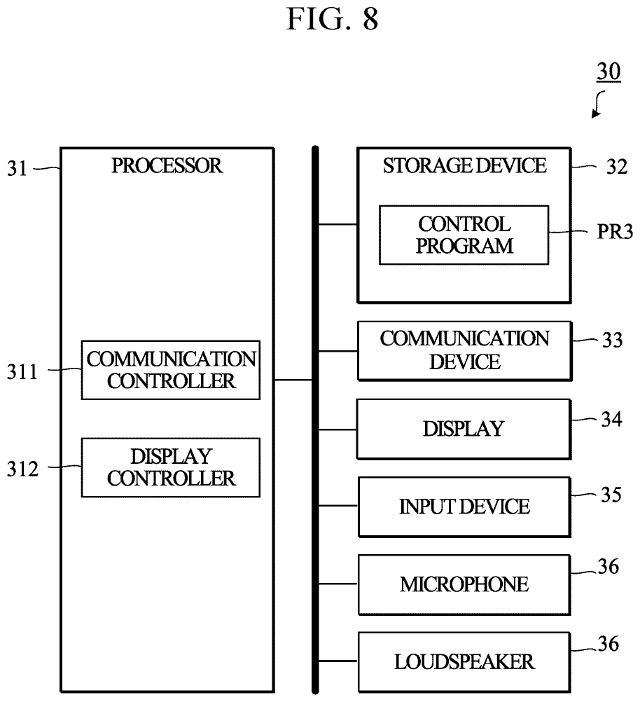

FIG. 8 is a block diagram showing an example of a configuration of the terminal device 30. The terminal device 30 includes a processor 31, a storage device 32, a communication device 33, a display 34, an input device 35, a microphone 36, and a loudspeaker 37. Each element of the terminal device 30 is interconnected by a single bus or by multiple buses for communicating information.

The processor 31 is a processor that controls the entire terminal device 30. In addition, the processor 31 is constituted by use of a single chip or by use of multiple chips, for example. The processor 31 is constituted by use of a central processing unit (CPU) that includes, for example, interfaces for peripheral devices, arithmetic units, registers, etc. It should be noted that some or all of the functions of the processor 31 may be implemented by hardware such as a DSP, an ASIC, a PLD, or a FPGA, etc. The processor 31 executes various types of processing in parallel or sequentially.

The storage device 32 is a recording medium that can be read from and be written to by the processor 31. In addition, the storage device 32 stores a plurality of programs including a control program PR3 to be executed by the processor 31.

The communication device 33 is hardware that is a transmitting and receiving device configured to communicate with other devices. For example, the communication device 33 may be referred to as a network device, a network controller, a network card, a communication module, etc. The communication device 33 may include a connector for wired connection and may include an interface circuit corresponding to the connector. In addition, the communication device 33 may include a wireless communication interface. The connector for wired connection and the interface circuit may conform to wired LAN, IEEE1394, or USB. In addition, the wireless communication interface may conform to wireless LAN or Bluetooth (registered trademark), etc.

The display 34 is a device that displays images and text information. The display 34 displays various images under the control of the processor 31. For example, various display panels, such as liquid crystal display panels, and organic electro-luminescent (EL) display panels, are suitably used as the display 34.

The input device 35 is a device that receives an operation made by the user U of the terminal device 30. For example, the input device 35 includes a keyboard and a pointing device such as a touch pad, a touch panel, or a mouse. Here, when a touch panel is included, the input device 35 may serve as the display 34.

The microphone 36 is a device for receiving surrounding sounds. For example, when the terminal device 30 is the terminal device 30-J used by the user UJ, the microphone 36 receives sounds uttered by the user UJ. The microphone 36 outputs the received sounds as an audio signal.

The loudspeaker 37 is a device for emitting sounds. For example, when the terminal device 30 is the terminal device 30-J used by the user UJ and when the user UJ and the user UK have a voice conversation with each other, the loudspeaker 37 emits sounds of the user UK.

The processor 31 reads the control program PR3 from the storage device 32 and executes it to function as a communication controller 311 and a display controller 312, for example.

The communication controller 311 causes the communication device 33 to exchange various information with the server 10. For example, the communication controller 311 causes receipt of image information, which indicates an image of the virtual space VS, from the server 10. As described above, the virtual space VS includes the avatar image AP representative of the avatar A corresponding to the user U. In addition, the communication controller 311 causes the communication device 33 to transmit the operation information for the user U to operate the avatar A and the communication information input by the user U to the server 10.

The display controller 312 causes, based on the image information indicative of the image of the virtual space VS received by the communication controller 311, the display 34 to display the image of the virtual space VS.

### 1-2: Operation of Embodiment

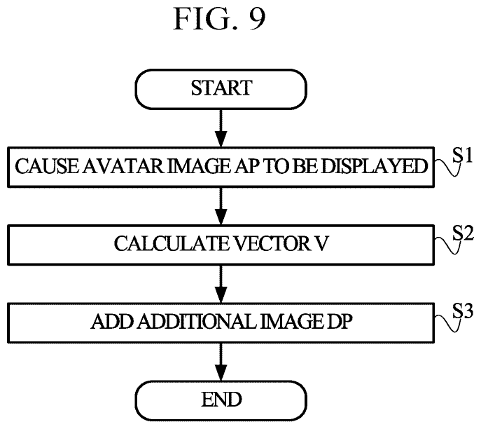

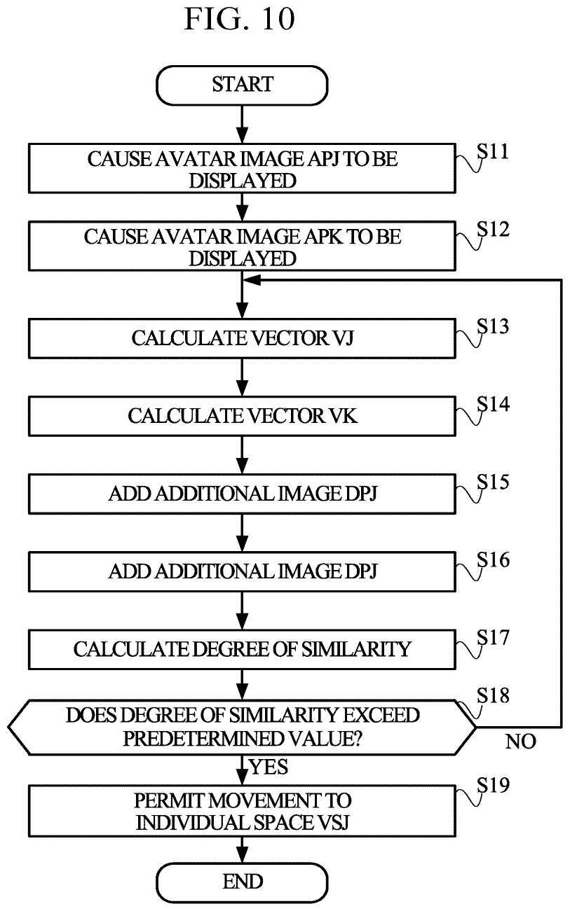

Hereinafter, an operation of the display control system 1 according to the embodiment will be described with reference to FIG. 9 and FIG. 10.

### 1-2-1: Operation of Addition of Visual Effect

FIG. 9 is a flowchart showing an example of an operation of the server 10 adding a visual effect to the avatar image APJ.

In step S1, the processor 11 functions as the display controller 113. The processor 11 causes the terminal device 30 to display the avatar image APJ indicative of the avatar AJ corresponding to the user UJ.

In step S2, the processor 11 functions as the vector calculator 115. The processor 11 calculates the vector VJ relating to the sense of values of the user UJ.

In step S3, the processor 11 functions as the effect imparter 116. The processor 11 adds the additional image DP to the avatar image APJ in accordance with the vector VJ calculated in step S2.

### 1-2-2: Operation of Permission to Move to Individual Space

FIG. 10 is a flowchart showing an example of an operation in which the avatar AK is permitted to move to the individual space VSJ.

In step S11, the processor 11 functions as the display controller 113. The processor 11 causes the terminal device 30 to display the avatar image APJ indicative of the avatar AJ corresponding to the user UJ.

In step S12, the processor 11 functions as the display controller 113. The processor 11 causes the terminal device 30 to display the avatar image APK indicative of the avatar AK corresponding to the user UK.

In step S13, the processor 11 functions as the vector calculator 115. The processor 11 calculates the vector VJ relating to the sense of values of the user UJ.

In step S14, the processor 11 functions as the vector calculator 115. The processor 11 calculates the vector VK relating to the sense of values of the user UK.

In step S15, the processor 11 functions as the effect imparter 116. The processor 11 adds an visual effect to the avatar image APJ in accordance with the vector VJ calculated in step S13.

In step S16, the processor 11 functions as the effect imparter 116. The processor 11 adds a visual effect to the avatar image APK in accordance with the vector VK calculated in step S14.

In step S17, the processor 11 functions as the similarity calculator 117. The processor 11 calculates the degree of similarity between the sense of values of the user UJ and the sense of values of the user UK based on the vector VJ calculated in step S13 and the vector VK calculated in step S14.

Instep S18, the processor 11 functions as the similarity calculator 117. In determining that the degree of similarity calculated in step S17 exceeds a predetermined value, the processor 11 executes processing in step S19. On the other hand, in determining that the degree of similarity calculated in step S17 is less than or equal to the predetermined value, the processor 11 executes processing in step S13.

In step S19, the processor 11 functions as the permitter 119. The processor 11 permits the avatar AK to move to the individual space VSJ.

### 1-3: Effects Provided by Embodiment

According to the above description, the server 10, which serves as the display control apparatus according to the present embodiment, includes the display controller 113, the vector calculator 115, and the effect imparter 116. The display controller 113 causes the avatar image AP indicative of the avatar A corresponding to the user U to be displayed in the virtual space VS. The vector calculator 115 calculates the vector V relating to the sense of values of the user U. The effect imparter 116 adds a visual effect to the avatar image AP in accordance with the calculated vector V.

Since the server 10 includes the above configuration, it is possible to add a visual effect to the avatar A based on the sense of values of the user U. As described above, in the psychology of the user U, the sense of values of the user U is in a layer that is deeper than a layer including an emotion of the user U. Thus, the server 10 can add a visual effect, which is more closely associated with the personality of the user U, to the avatar image AP. In addition, the visual effect is less affected by a temporary emotional state of the user U. Thus, the server 10 according to the present invention can stably add a visual effect unique to the user U to the avatar image AP.

Furthermore, in the server 10 according to the present embodiment, the effect imparter 116 adds the additional image DP dependent on the sense of values, as the visual effect described above, around the avatar image AP.

Since the server 10 includes the above configuration, the additional image DP is added around the avatar image AP; thus, the user U can visually recognize the avatar image AP and the additional image DP as a single body.

Furthermore, in the server 10 according to the present embodiment, the vector calculator 115 calculates the vector V based on a word contained in a message transmitted by the user U in the virtual space VS.

Since the server 10 includes the above configuration, it is possible to calculate a vector relating to the sense of values of the user U based on a word contained in a message transmitted by the user U. Consequently, the user U can add a visual effect, which is based on the sense of values of the user U, to the avatar image AP only by carrying out a text chat or voice communication via the avatar A corresponding to the user U in the virtual space VS.

Furthermore, in the server 10 according to the present embodiment, the display controller 113 causes the avatar image APJ, which serves as a first avatar image and represents the avatar AJ that serves as a first avatar corresponding to the user UJ that serves as a first user, and the avatar image APJ, which serves as a second avatar image and represents the avatar AK that serves as a second avatar corresponding to the user UK that serves as a second user, to be displayed. The vector calculator 115 calculates the vector VJ, which serves as a first vector relating to the sense of values of the user UJ, and the vector VK, which serves as a second vector relating to the sense of values of the user UK. In addition, the server 10 further includes the similarity calculator 117. The similarity calculator 117 calculates the degree of similarity between the sense of values of the user UJ and the sense of values of the user UK based on the vector VJ and the vector VK. The effect imparter 116 adds the additional image DPJ that serves as a first additional image dependent on the sense of values of the user UJ, as the visual effect, around the avatar image APJ. In addition, the effect imparter 116 adds the additional image DPK, which serves as a second additional image dependent on the sense of values of the user UK, around the avatar image APK. In addition, the effect imparter 116 changes the additional image DPJ and the additional image DPK based on the degree of similarity.

Since the server 10 includes the above configuration, each of the user UJ and the user UK can understand the degree of similarity between the sense of values of the user UJ and the sense of values of the user UK simply by visually recognizing the additional image DPJ and the additional image DPK.

In addition, the server 10 according to the present embodiment further includes the intimacy calculator 118. The intimacy calculator 118 calculates the degree of intimacy indicative of the degree of intimacy between the user UJ and the user UK based on communication between the user UJ and the user UK. The effect imparter 116 changes the additional image DPJ and the additional image DPK based on the degree of similarity and the degree of intimacy.

Since the server 10 includes the above configuration, each of the user UJ and the user UK can understand the degree of intimacy between the user UJ and the user UK in the virtual space VS only by visually recognizing the additional image DPJ and the additional image DPK.

In addition, the server 10 according to the present embodiment further includes the permitter 119. The permitter 119 permits, in accordance with the degree of similarity, the avatar AK to move to the individual space VSJ, which serves as a first individual space managed by the user UJ in the virtual space VS.

Since the server 10 includes the above configuration, when the sense of values of the user UK is similar to the sense of values of the user UJ in the virtual space VS, it is possible to move to the individual space VSJ into which a user U, who has a sense of values not similar to the sense of values of the user UJ, cannot move. In addition, the user UJ can open the individual space VSJ only to the user UK who has the sense of values similar to the sense of values of the user UJ.

Furthermore, in the server 10 according to the present embodiment, the permitter 119 may permit, in accordance with the degree of similarity and the degree of intimacy, the avatar AK to move to the individual space VSJ.

Since the server 10 includes the above configuration, in becoming intimately acquainted with the user UJ in the virtual space VS, the user UK can move to the individual space VSJ into which a user U, who is not intimately acquainted with the user UJ, cannot move. In addition, the user UJ can open the individual space VSJ only to the user UK who is intimately acquainted with the user UJ.

Furthermore, the server 10 according to the present embodiment may permit, based on a relative positional relationship between the avatar image APJ and the avatar image APK in the virtual space VS in addition to the degree of similarity and the degree of intimacy, the avatar AK to move to the individual space VSJ.

Since the server 10 includes the above configuration, in having a predetermined positional relationship to the user UJ in the virtual space VS, the user UK can move to the individual space VSJ into which a user U, who does not have the predetermined positional relationship to the user UJ, cannot move. In addition, the user UJ can open the individual space VSJ only to the user UK who has the predetermined positional relationship to the user UJ.

Furthermore, in the server 10 according to the present embodiment, the effect imparter 116 may add the visual effect in a case in which the user UJ is allowed to have a conversation with the user UK in the virtual space VS.

Since the server 10 includes the above configuration, by confirming whether the visual effect is added to the avatar image APJ corresponding to the user UJ, the user UK can recognize whether the user UJ is in a state in which a conversation is allowed or is in a state in which a conversation is not allowed.

### 2: Modifications

This disclosure is not limited to the embodiment described above. Specific modifications will be explained below. Two or more modifications freely selected from the following modifications may be combined.

### 2-1: Modification 1

In the above-described embodiment, the terminal device 30 includes the display 34. However, the terminal device 30 may include, in place of the display 34 or in addition to the display 34, a head-mounted display (HMD) to be worn on the head of the user U. In this instance, an image representative of the virtual space VS including the avatar image AP is displayed on the head-mounted display. The head-mounted display may include a line-of-sight detector that detects a line of sight of the user U, and a movement detector that detects movement of the user U using, for example, an acceleration sensor and a gyro sensor. When the head-mounted display includes the line-of-sight detector and the movement detector, line-of-sight information, which indicates the line of sight of the user U detected by the head-mounted display, and movement information, which indicates the movement of the user U, are transmitted to the server 10 via the terminal device 30. The avatar generator 111 included in the server 10 may generate the avatar image AP by using the line-of-sight information and the movement information. In addition, the operation controller 114 included in the server 10 may move the avatar image AP by using the line-of-sight information and the movement information.

### 2-2: Modification 2

In the above-described embodiment, provided that the degree of similarity between the user UJ and the user UK calculated by the similarity calculator 117 exceeds a predetermined value, the display controller 113 causes the individual space VSJ to be displayed in the virtual space VS, for example. However, the display controller 113 may cause the individual space VSJ to be always displayed in the virtual space VS. In this instance, provided that the degree of similarity between the user UJ and the user UK calculated by the similarity calculator 117 exceeds the predetermined value, the permitter 119 opens the entrance G of the individual space VSJ only to the avatar AK. Consequently, the permitter 119 permits the avatar AK to move to the individual space VSJ. In the modification 2, the individual space VSJ is visually recognized by all users U, whereas the entrance G is open only to the user UK, the degree of similarity between the sense of values of the user UK and the sense of values of the user UJ exceeding the predetermined value.

### 2-3: Modification 3

The server 10 according to the above-described embodiment may further include a matching function. For example, the server 10 displays, in the virtual space VS, a list of multiple avatar images AP stored in the avatar database ADB. The user U selects the user's favorite avatar image AP from the list of the multiple avatar images AP displayed in the virtual space VS. As a result, in the virtual space VS viewed by a user UA, an icon may be displayed that has a function to talk to a different user UB corresponding to an avatar image AP that is a favorite of the user UA. Alternatively, the server 10 may have a function to introduce to a user UA a different user UB, who has a sense of values similar to that of the user UA, based on the user information UI stored in the storage device 12. In addition, when the user UA talks to the different user UB by using these matching functions, the server 10 may have a recommendation function to suggest topics to be spoken.

### 2-4: Modification 4

The avatar generator 111 may generate the avatar image AP using a trained model generated as a result of machine learning. For example, the trained model may be a trained model generated by being trained to learn, as training data, a plurality of sets in each of which personality information relating to personality of a certain user UA and an avatar image APA corresponding to the user UA are in one-to-one correspondence with each other. In this instance, the avatar generator 111 may enter personality information relating to personality of a different user UC included in the user information UI into the trained model, thereby causing the trained model to output an avatar image APC corresponding to the user UC.

### 2-5: Modification 5

In the above-described embodiment, the additional image DP is represented as an aura that swirls around a body part of the avatar image AP. However, a mode of the additional image DP is not limited thereto. For example, the additional image DP may be a cylindrical or spherical aura surrounding the avatar image AP. Alternatively, the additional image DP may be an annular aura with a diameter in a direction of height of the avatar image AP.

### 2-6: Modification 6

In the above-described embodiment, the vector calculator 115 calculates, as the value information relating to the sense of values of the user U, the vector V relating to the sense of values of the user U. In addition, the effect imparter 116 adds a visual effect to the avatar image AP in accordance with the vector V calculated by the vector calculator 115. However, the server 10 may include, in place of the vector calculator 115, a scalar calculator that calculates a scalar relating to the sense of values of the user U as the value information relating to the sense of values of the user U. In this instance, the effect imparter 116 adds a visual effect to the avatar image AP in accordance with the scalar calculated by the scalar calculator.

### 3: Other Matters

(1) In the foregoing embodiment, the storage devices 12 and 32 are each, for example, a ROM and a RAM; however, the storage devices may include flexible disks, magneto-optical disks (e.g., compact disks, digital multi-purpose disks, Blu-ray (registered trademark) discs, smartcards, flash memory devices (e.g., cards, sticks, key drives), Compact Disc-ROMs (CD-ROMs), registers, removable discs, hard disks, floppy (registered trademark) disks, magnetic strips, databases, servers, or other suitable storage mediums. In addition, the program may be transmitted from a network via telecommunication lines. Alternatively, the program may be transmitted from the communication network NET via telecommunication lines.
(2) In the foregoing embodiment, information, signals, etc., may be presented by use of various techniques. For example, data, instructions, commands, information, signals, bits, symbols, chips, etc., may be presented by freely selected combination of voltages, currents, electromagnetic waves, magnetic fields or magnetic particles, light fields or photons.
(3) In the foregoing embodiment, the input and output of information, or the input or the output of information, etc., may be stored in a specific location (e.g., memory) or may be managed by use of a management table. The information, etc., that is, the input and output, or the input or the output, may be overwritten, updated, or appended. The information, etc., that is output may be deleted. The information, etc., that is input may be transmitted to other devices.
(4) In the foregoing embodiment, determination may be made based on values that can be represented by using one bit (0 or 1), may be made based on Boolean values (true or false), or may be made based on comparing numerical values (for example, comparison with a predetermined value).
(5) The order of processes, sequences, flowcharts, etc., that have been used to describe the foregoing embodiment may be modified as long as they do not conflict. For example, although a variety of methods has been illustrated in this disclosure with a variety of elements of steps in exemplary orders, the specific orders presented herein are by no means limiting.
(6) Each function shown in FIG. 1 through FIG. 2 and FIG. 8 is implemented by any combination of hardware and software. In addition, the method for realizing each functional block is not limited thereto. In other words, each functional block may be implemented by one device that is physically or logically aggregated. Alternatively, each functional block may be realized by directly or indirectly connecting two or more physically and logically separate, or physically or logically separate, devices (by using cables and radio, or cables, or radio, for example), and using these devices. The functional block may be realized by combining the software with one device described above or two or more of these devices.
(7) The programs shown in the foregoing embodiment should be widely interpreted as an instruction, an instruction set, a code, a code segment, a program code, a subprogram, a software module, an application, a software application, a software package, a routine, a subroutine, an object, an executable file, an execution thread, a procedure, a function, or the like, regardless of whether it is called software, firmware, middleware, microcode, hardware description language, or other names.

In addition, software, instructions, etc., may be transmitted and received via communication media. For example, when software is transmitted from a website, a server, or other remote sources, by using wired technologies such as coaxial cables, optical fiber cables, twisted-pair cables, and digital subscriber lines (DSL), and wireless technologies such as infrared radiation and radio and microwaves by using wired technologies, or by wireless technologies, these wired technologies and wireless technologies, wired technologies, or wireless technologies, are also included in the definition of communication media.
(8) In each aspect described above, the terms “system” and “network” are used interchangeably.
(9) The information and parameters described in this disclosure may be represented by absolute values, may be represented by relative values with respect to predetermined values, or may be represented by using other pieces of applicable information.
(10) In the foregoing embodiment, the server 10 and the terminal devices 30-1 through 30-may each be a mobile station (MS). A mobile station may be referred to, by one skilled in the art, as a “subscriber station”, a “mobile unit”, a “subscriber unit”, a “wireless unit”, a “remote unit”, a “mobile device”, a “wireless device”, a “wireless communication device”, a “remote device”, a “mobile subscriber station”, an “access terminal”, a “mobile terminal”, a “wireless terminal”, a “remote terminal”, a “handset”, a “user agent”, a “mobile client”, a “client”, or some other suitable terms. The terms “mobile station”, “user terminal”, “user equipment (UE)”, “terminal”, etc., may be used interchangeably in the present disclosure.
(11) In the foregoing embodiment, the terms “connected” and “coupled”, or any modification of these terms, may mean all direct or indirect connections or coupling between two or more elements, and may include the presence of one or more intermediate elements between two elements that are “connected” or “coupled” to each other. The coupling or connection between the elements may be physical coupling or connection, logical coupling or connection, or a combination thereof. For example, “connection” may be replaced with “access.” As used in this specification, two elements may be considered “connected” or “coupled” to each other by using one or more electrical wires, cables, and printed electrical connections, or by using one or more electrical wires, cables, or printed electrical connections. In addition, two elements may be considered “connected” or “coupled” to each other by using electromagnetic energy, etc., which is a non-limiting and non-inclusive example, having wavelengths in radio frequency regions, microwave regions, and optical (both visible and invisible) regions.
(12) In the foregoing embodiment, the phrase “based on” does not mean “based only on”, unless specified otherwise. In other words, the phrase “based on” means both “based only on” and “based at least on.”
(13) The term “determining” as used in this specification may encompass a wide variety of actions. For example, the term “determining” may be used when practically “determining” that some act of calculating, computing, processing, deriving, investigating, looking up (for example, looking up a table, a database, or some other data structure), ascertaining, etc., has taken place. Furthermore, “determining” may be used when practically “determining” that some act of receiving (for example, receiving information), transmitting (for example, transmitting information), inputting, outputting, accessing (for example, accessing data in a memory) etc., has taken place. Furthermore, “determining” may be used when practically “determining” that some act of resolving, selecting, choosing, establishing, comparing, etc., has taken place. In other words, “determining” may be used when practically determining to take some action. In addition, the term “determining” may be replaced with “assuming”, “expecting”, “considering”, etc.
(14) As long as terms such as “include”, “including” and modifications thereof are used in the foregoing embodiment, these terms are intended to be inclusive, in a manner similar to the way the term “comprising” is used. In addition, the term “or” used in the specification or in claims is not intended to be an exclusive OR.
(15) In the present disclosure, for example, when articles such as “a”, “an”, and “the” in English are added in translation, these articles include plurals unless otherwise clearly indicated by the context.
(16) In this disclosure, the phrase “A and B are different” may mean “A and B are different from each other.” It should be noted that the phrase “A and B are each different from C” may mean that “A and B are different from C”. Terms such as “separated” and “combined” may be interpreted in the same way as “different.”
(17) The examples and embodiments illustrated in this specification may be used individually or in combination, which may be altered depending on the mode of implementation. In addition, a predetermined piece of information (for example, a report to the effect that something is “X”) does not necessarily have to be indicated explicitly, and may be indicated in an implicit way (for example, by not reporting this predetermined piece of information, by reporting another piece of information, etc.).

Although this disclosure is described in detail, it is obvious to those skilled in the art that the present invention is not limited to the embodiments described in the specification. This disclosure can be implemented with a variety of fixes and in a variety of modifications, without departing from the spirit and scope of the present invention defined as in the recitations of the claims. Consequently, the description in this specification is provided only for the purpose of explaining examples and should by no means be construed to limit the present invention in any way.

### DESCRIPTION OF REFERENCE SIGNS

1 . . . display control system, 10 . . . server, 11 . . . processor, 12 . . . storage device, 13 . . . communication device, 14 . . . display, 15 . . . input device, 30 . . . terminal device, 31 . . . processor, 32 . . . storage device, 33 . . . communication device, 34 . . . display, 35 . . . input device, 36 . . . microphone, 37 . . . loudspeaker, 111 . . . avatar generator, 112 . . . acquirer, 113 . . . display controller, 114 . . . operation controller, 115 . . . vector calculator, 115-1 . . . log acquirer, 115-2 . . . entity extractor, 115-3 . . . graph generator, 115-4 . . . calculator, 116 . . . effect imparter, 117 . . . similarity calculator, 118 . . . intimacy calculator, 119 . . . permitter, 120 . . . communication controller, 311 . . . acquirer, 312 . . . display controller, 313 . . . operation controller, 314 . . . communication controller, PR1 . . . control program, PR3 . . . control program.

1. A display control apparatus comprising:
a display controller configured to cause an avatar image indicative of an avatar corresponding to a user to be displayed in a virtual space;
a generator configured to generate value information relating to a sense of values of the user; and
an effect imparter configured to add a visual effect to the avatar image in accordance with the value information generated by the generator.

2. The display control apparatus according to claim 1, wherein the generator is configured to calculate, as the value information, a vector relating to the sense of values of the user.

3. The display control apparatus according to claim 2, wherein the effect imparter is configured to add an additional image dependent on the sense of values, as the visual effect, around the avatar image.

4. The display control apparatus according to claim 2, wherein the generator is configured to calculate the vector based on a word contained in a message transmitted by the user in the virtual space.

5. The display control apparatus according to claim 3,
wherein the user is a first user,
wherein the vector is a first vector,
wherein the additional image is a first additional image,
wherein the display controller is configured to cause a first avatar image, which represents a first avatar corresponding to the first user, and a second avatar image, which represents a second avatar corresponding to a second user, to be displayed, and
wherein the generator is configured to calculate the first vector and a second vector relating to a sense of values of the second user,
the display control apparatus further comprising:
a similarity calculator configured to calculate a degree of similarity between the sense of values of the first user and the sense of values of the second user, based on the first vector and the second vector,
wherein the effect imparter is configured to:
add a second additional image dependent on the sense of values of the second user, as the visual effect, around the second avatar image; and
change the first additional image and the second additional image based on the degree of similarity.

6. The display control apparatus according to claim 5, further comprising:
an intimacy calculator configured to calculate, based on communication between the first user and the second user, a degree of intimacy between the first user and the second user,
wherein the effect imparter is configured to change the first additional image and the second additional image based on the degree of similarity and the degree of intimacy.

7. The display control apparatus according to claim 2,
wherein the user is a first user,
wherein the vector is a first vector,
wherein the display controller is configured to cause the first avatar image and a second avatar image, which represents a second avatar corresponding to a second user, to be displayed, and
wherein the generator is configured to calculate the first vector relating to the sense of values of the first user and a second vector relating to a sense of values of the second user,
the display control apparatus further comprising:
a similarity calculator configured to calculate, based on the first vector and the second vector, a degree of similarity between the sense of values of the first user and the sense of values of the second user; and
a permitter configured to permit, in accordance with the degree of similarity, the second avatar to move to a first individual space managed by the first user in the virtual space.

8. The display control apparatus according to claim 7, further comprising:
an intimacy calculator configured to calculate, based on communication between the first user and the second user, a degree of intimacy between the first user and the second user,
wherein the permitter is configured to permit, based on the degree of similarity and the degree of intimacy, the second avatar to move to the first individual space.

9. The display control apparatus according to claim 8, wherein the permitter is configured to permit, based on a relative positional relationship between the first avatar image and the second avatar image in the virtual space in addition to the degree of similarity and the degree of intimacy, the second avatar to move to the first individual space.

10. The display control apparatus according to claim 1,
wherein the user is a first user, and
wherein the effect imparter is configured to add the visual effect in a case in which it is determined that the first user is in a state in which a conversation with the second user is allowed in the virtual space.
